(19) United States
(12) Patent Application Publication
(10) Pub. No.: US 2023/0303819 A1
(43) Pub. Date: Sep. 28, 2023

(54) PROCESS FOR MAKING MULTILAYER POLYMER PARTICLES IN AQUEOUS MEDIUM

(71) Applicant: BASF SE, Ludwighsfen am Rhein (DE)

(72) Inventors: Kaliappa RAGUNATHAN, Charlotte, NC (US); Timothy KLOTS, Wyandotte, MI (US)

(21) Appl. No.: 18/124,000

(22) Filed: Mar. 21, 2023

Related U.S. Application Data
(60) Provisional application No. 63/322,278, filed on Mar. 22, 2022.

(51) Int. Cl. C08L 33/12; C08L 33/08; C09D 133/08; C09D 133/12; C09D 5/00; C08F 220/14; C08F 220/18

(52) U.S. Cl. CPC C08L 33/12; C08L 33/08; C09D 133/08; C09D 133/12; C09D 5/00; C08F 220/14; C08F 220/1802; C08L 2207/53; C08L 2201/50

(57) ABSTRACT

The present disclosure provides multilayer particles comprising (i) a first layer comprising a first copolymer with an Mn of greater than 50,000 g/mol derived from one or more soft ethylenically-unsaturated monomers, and one or more phosphorus-containing monomer; and (ii) a second layer surrounding at least a portion of the first layer comprising a second polymer having an Mn of 500 g/mol to 50,000 g/mol, derived from one or more ethylenically-unsaturated monomer, and at least one ethylenically unsaturated acid monomer, wherein the second layer is prepared by a high temperature polymerization process. The present disclosure further provides methods of making the multilayer particles.

### FIELD OF THE DISCLOSURE

The present disclosure relates generally to multistage polymers, as well as coating compositions containing multistage polymers for use in a variety of applications.

### BACKGROUND

Paints and coatings based on emulsion polymers, generally referred to as “latex” paints or coatings, are well known and widely used in a variety of applications. In particular, latex paints have captured a significant portion of the indoor and outdoor paint market, primarily because of their significant advantages over organic solvent-based paints. For example, latex paints offer easier cleanup than solvent-based paints. Latex paints also provide for reduced levels of volatile organic solvents as compared to solvent-based paints.

In spite of their many advantages, the coating properties and storage stability of many latex paints can be inferior to those of solvent-based paints. For example, coatings formed from latex paints often exhibit decreased durability and adhesion as compared to coatings formed from organic solvent-based paints. Thus, there is a continuing need for latexes which can provide coatings or films having excellent performance properties, including blocking resistance, water and chemical resistance (e.g., stain resistance), gloss, tint strength, scrub resistance, and excellent film formation.

### SUMMARY OF THE DISCLOSURE

Provided herein are multistage polymers that comprise (i) a first stage comprising a first copolymer having a first theoretical glass-transition temperature (T_{g}), the first copolymer having a number average molecular weight (Mn) of greater than 50,000 g/mol being derived from one or more of a soft ethylenically-unsaturated monomer and a phosphorus-containing monomer; and (ii) a second stage comprising a second polymer having an Mn of 500 g/mol to 50,000 g/mol and a second theoretical T_{g}, the second polymer being derived from one or more ethylenically-unsaturated monomers and at least one ethylenically unsaturated acid monomer. The multistage polymers can be in the form of multilayer particles that comprise (i) a first layer comprising a first copolymer having an Mn of greater than 50,000 g/mol and a first theoretical T_{g}, the first copolymer being derived from at least one of soft ethylenically-unsaturated monomer and a phosphorus-containing monomer; and (ii) a second layer surrounding at least a portion of the first layer comprising a second polymer having an Mn of 500 g/mol to 50,000 g/mol and a second theoretical T_{g}, the second polymer being derived from one or more ethylenically-unsaturated monomers and at least one ethylenically unsaturated acid monomer.

A first embodiment is a multilayer particle comprising: (i) a first layer comprising a first copolymer with an Mn of greater than 50,000 g/mol derived from one or more soft ethylenically-unsaturated monomers, and one or more phosphorus-containing monomer; and (ii) a second layer surrounding at least a portion of the first layer comprising a second polymer having an Mn of 500 g/mol to 50,000 g/mol, derived from one or more ethylenically-unsaturated monomer, and at least one ethylenically unsaturated acid monomer, wherein the second layer is prepared by a high temperature polymerization process.

A second embodiment is the multilayer particle of the first embodiment, wherein the monomers are selected from the group consisting of methyl (meth)acrylate, 2-ethyl (meth)acrylate, n-butyl (meth)acrylate, 2-ethyl(meth)acrylate, t-butyl (meth)acrylate, i-butyl (meth)acrylate, cyclohexyl(meth)acrylate, 2-ethylhexyl (meth)acrylate, 2-octyl (meth)acrylate, i-bornyl(meth)acrylate, styrene, (meth)acrylic acid, itaconic acid, sulfur acid monomers and phosphorous acid monomers.

A third embodiment is the multilayer particle of either the first embodiment or the second embodiment, wherein the second polymer is a hydrophilic polymer.

A fourth embodiment is the multilayer particle of either the first embodiment or the second embodiment or the third embodiment, wherein the second polymer has ethylenically unsaturated bonds.

A fifth embodiment is the multilayer particle of any one of the first to fourth embodiments, wherein the first copolymer is derived from: (i) greater than 50% by weight of the total first layer monomer comprising one or more soft (meth)acrylate monomers; and (ii) from 0.1% by weight to 5% by weight of the total first layer monomers comprising one or more phosphorus acid-containing monomers.

A sixth embodiment is the multilayer particle of any one of the first through fifth embodiments, wherein the second copolymer is derived from: (i) greater than 10% by weight of the total second layer monomer comprising at least one of one or more hard (meth)acrylate monomers, and styrene; and (ii) from 2% by weight to 20% by weight of the total second layer monomers comprising one or more acid-containing monomer.

A seventh embodiment is the multilayer particle of any one of the first through sixth embodiments, wherein the second polymer comprises 2.5 wt. % to 40 wt. % of the total particle weight.

An eighth embodiment is the multilayer particle of any one of the first through seventh embodiments, wherein the first copolymer exhibits a Tg, as measured by differential scanning calorimetry (DSC) using the mid-point temperature as described in ASTM D3418-15, from −100° C. to 50° C.

A ninth embodiment is the multilayer particle of any one of the first through eighth embodiments, wherein the second copolymer exhibits a Tg, as measured by differential scanning calorimetry (DSC) using the mid-point temperature as described in ASTM D3418-15, from −50 ° C. to 250° C.

A tenth embodiment is the multilayer particle of any one of the first through ninth embodiments, wherein the first copolymer comprises styrene, methyl (meth)acrylate, n-butyl(meth)acrylate, 2-ethyl(meth)acrylate, t-butyl(meth)acrylate, i-butyl(meth)acrylate, cyclohexyl(meth)acrylate, 2-ethylhexyl (meth)acrylate, 2-octyl (meth)acrylate, i-bornyl(meth)acrylate, or a combination thereof

An eleventh embodiment is the multilayer particle of any one of the first through tenth embodiments, wherein the second copolymer comprises methyl (meth)acrylate, 2-ethyl(meth)acrylate, styrene, n-butyl (meth)acrylate, t-butyl (meth)acrylate, i-butyl (meth)acrylate, cyclohexyl (meth)acrylate, 2-ethylhexyl (meth)acrylate, 2-octyl (meth)acrylate, i-bornyl(meth)acrylate or a combination thereof.

A twelfth embodiment is the multilayer particle of any one of the first through eleventh embodiments, wherein the at least one ethylenically unsaturated acid monomer is selected from the group consisting of carboxylic acid-monomer, dicarboxylic acid monomer, sulfur acid-monomer, phosphorous acid-monomer, and combinations thereof.

A thirteenth embodiment is the multilayer particle of the twelfth embodiment, wherein the carboxylic acid- containing monomers are selected from the group consisting of acrylic acid, methacrylic acid, itaconic acid, maleic acid, fumaric acid, and combinations thereof.

A fourteenth embodiment is the multilayer particle of any one of the first through thirteenth embodiments, wherein the phosphorus-containing monomers are selected from the group consisting of 2-phosphoethyl (meth)acrylate, 2- phosphopropyl (meth)acrylate, 3-phosphopropyl (meth)acrylate, 4-phosphobutyl (meth)acrylate, 3-phospho-2-hydroxypropyl (meth)acrylate, vinylphosphonic acid, methyl vinylphosphonic acid, alkyl or ethyl methacrylate phosphate, phosphate esters of polypropylene glycol mono (meth)acrylate, phosphate esters of polyethylene glycol mono (meth)acrylate, phosphate esters of mixture of polypropylene glycol mono (meth)acrylate and polyethylene glycol mono (meth)acrylate, and mixtures thereof.

A fifteenth embodiment is the multilayer particle of any one of the first through fourteenth embodiments, wherein the weight ratio of the first copolymer to the second copolymer is in a range of from 40:60 to 95:5.

A sixteenth embodiment is the multilayer particle of any one of the first through fifteenth embodiments, wherein the first polymer further comprises a self-crosslinker selected from the group consisting of a combination of acetoacetyl ethyl methacrylate (AAEM) and a polyamine or, a combination of diacetone acrylamide (DAAM) and adipic dihydrazide (ADDH).

A seventeenth embodiment is a method of producing the multilayer particles of any preceding embodiments, the method comprising: a) producing a first layer comprising a first polymer by emulsion polymerization; b) producing a second polymer by high temperature polymerization; c) forming an aqueous solution comprising the second polymer; and d) feeding the aqueous solution comprising the second polymer on to the first layer in the presence of a free radical polymerization initiator.

An eightteenth embodiment is the method of the seventeenth embodiment, wherein the emulsion polymerization is carried out at a first temperature of less than or equal to 95° C., and the high temperature polymerization is carried out at a second temperature of greater than or equal to 150° C.

A nineteenth embodiment is the method of the seventeenth embodiment, wherein step d) is conducted at a temperature greater than 70° C.

A twentieth embodiment is a composition comprising the multilayer particles of any one of the first through nineteenth embodiments, wherein the composition comprises an aqueous dispersion.

A twenty-first embodiment is the composition of the twentieth embodiment, wherein the aqueous dispersion includes greater than 40% solids.

A twenty-second embodiment is a coating, comprising: the aqueous composition of either the twentieth embodiment or the twenty-first embodiment; and one or more of pigments, dispersants, fillers, coalescents, pH modifying agents, plasticizers, defoamers, surfactants, thickeners, biocides, co-solvents, and combinations thereof.

A twenty-third embodiment is a method of producing the multilayer particles of any preceding embodiments, the method comprising: a) producing a first layer comprising a first polymer by emulsion polymerization; b) producing a second polymer by high temperature polymerization;
c) forming an aqueous solution comprising the second polymer and one or more ethylenically unsaturated monomer; and d) feeding the aqueous solution comprising the second polymer and the one or more ethylenically unsaturated monomer onto the first layer in the presence of a free radical polymerization initiator.

A twenty-fourth embodiment is the method of the twenty-third embodiment, wherein the one or more ethylenically unsaturated monomer is selected from the group consisting of methyl (meth)acrylate, 2-ethyl(meth)acrylate, n-butyl (meth)acrylate, t-butyl (meth)acrylate, i-butyl (meth)acrylate, cyclohexyl(meth)acrylate, 2-ethylhexyl (meth)acrylate, 2-octyl (meth)acrylate, i-bornyl(meth)acrylate, styrene, a (meth)acrylic acid, itaconic acid, sulfur acid monomers and phosphorous acid monomers.

A twenty-fifth embodiment is the method of the twenty-third embodiment, wherein the one or more ethylenically unsaturated monomer does not include acid functional monomers (meth)acrylic acid, itaconic acid, sulfur acid monomers and phosphorous acid monomers

A twenty-sixth embodiment is the method of any one of the twenty-third through twenty-fifth embodiments, wherein the one or more ethylenically unsaturated monomer includes a self-crosslinker selected from the group consisting of a combination of acetoacetyl ethyl (meth)acrylate (AAEM) and a polyamine or, a combination of diacetone acrylamide (DAAM) and adipic dihydrazide (ADDH).

A twenty-seventh embodiment is the method of the twenty-third embodiment, wherein steps c is substantially free of surfactants.

A twenty-eighth embodiment is the method of the twenty-third embodiment, where the weight ratio of first layer polymers to second layer polymers is 50:50 to 97.5 to 2.5.

A twenty-nineth embodiment is a multilayer particle comprising: (i) a first layer comprising a first copolymer with an Mn of greater than 50,000 g/mol derived from one or more soft ethylenically-unsaturated monomers and one or more phosphorus-containing monomers; and (ii) a second layer surrounding at least a portion of the first layer comprising a second polymer having an Mn of 500 g/mol to 50,000 g/mol, derived from a polyurethane polymer.

### DETAILED DESCRIPTION

As used herein, the term “(meth)acrylate monomer” includes acrylate, methacrylate, and multi-unsaturated monomers such as diacrylate, di-methacrylate, triacrylate, tri-methacrylate, and tetra methacrylate monomers, among others, for example.

As used herein, the term “theoretical glass transition temperature” or “theoretical T_{g}” refers to the estimated T_{g} of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below:

1 Tg=wₐThₐ+w_{b}T g_{b}+ . . . +wᵢThᵢ

where wₐ is the weight fraction of monomer a in the copolymer, T_{ga} is the glass transition temperature of a homopolymer of monomer a, w_{b} is the weight fraction of monomer b in the copolymer, T_{gb} is the glass transition temperature of a homopolymer of monomer b, wi is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

As used herein, the term “number average molecular weight” (Mn) is the statistical average molecular weight of all polymer chains in a sample. Mn may be calculated according to the equation below:

$$Mn = \frac{\sum {N}_{i} {M}_{i}}{\sum {N}_{i}}$$

where Mᵢ is the molecular weight of a given chain and Nᵢ is the number of chains of that molecular weight.

Provided herein are multistage polymers that comprise (i) a first stage comprising a first copolymer having an Mn of greater than 50,000 g/mol and a first theoretical T_{g}, the first copolymer being derived from one or more of an soft ethylenically-unsaturated monomer and a phosphorus-containing monomer; and (ii) a second stage comprising a second polymer with having an Mn of 500 g/mol to 50,000 g/mol and a second theoretical T_{g}, the second polymer being derived from one or more ethylenically-unsaturated monomers and at least one ethylenically unsaturated acid monomer. The multistage polymers can be in the form of multilayer particles that comprise (i) a first layer comprising a first copolymer having a Mn of greater than 50,0000 g/mol and a first theoretical T_{g}, the first copolymer being derived from one or more of a soft ethylenically-unsaturated monomer and a phosphorus-containing monomer; and (ii) a second layer surrounding at least a portion of the first layer comprising a second polymer an Mn of 500 g/mol to 50,000 g/mol and a second theoretical T_{g}, the second polymer being derived from one or more ethylenically-unsaturated monomers and at least one ethylenically unsaturated acid monomer.

The multilayer particles can include a first layer and a second layer surrounding at least a portion of the first layer. For example, the multilayer particles can range from core-shell particles to so-called “acorn” particles, wherein the second layer surrounds a substantial portion of the first layer either in a continuous, semi-continuous or discontinuous fashion (e.g., such that the second layer forms 5% or greater, 10% or greater, 15% or greater, 20% or greater, 25% or greater, 30% or less, 35% or less, 40% or less, 45% or less, or 50% or less of the particle surface). In some embodiments, the first layer and the second layer form first and second domains within the multilayer particle, wherein the second layer surrounds at least a portion of the first layer. In some embodiments, the low molecular weight polymer synthesized by high temperature polymerization when dispersed into water may exist as particles and the particle size may range from 10 nm to 100 nm or 20 nm to 80 nm or 30 nm to 70 nm or 40 nm to 80 nm

In some embodiments the second layer may form raspberry like structure where small particles of second polymer are dotted onto the surface of the first layer particle. In some embodiments first layer particle have a volume average particle size of greater than 70 nm and the second polymer has a volume average particle size of less than 80 nm. In some embodiments the volume average particle size of the first layer polymer and the second layer polymer differ by greater than 20 nm, greater than 30 nm, greater than 50 nm, greater than 60 nm, greater than 100 nm and always second layer polymer particle size is smaller than the first layer polymer

In some embodiments, some of the second layer polymer particles may be present within the interstices of the first layer in addition to forming a layer around the first layer particles in a film formed from first and second layer polymers

The weight ratio of the first stage (or first layer) to the second stage (or second layer) can be about 40:60 or greater, about 50:50 or greater, about 60:40 or greater, about 70:30 or greater, about 80:20 or greater, about 90:10 or greater, or about 95:5 or greater, or any value encompassed by these endpoints, such as about 40:60 to about 95:5, about 70:30 to about 80:20, or about 50:50 to about 90:10, for example.

In some embodiments, the first stage polymers theoretical T_{g} can be about −100° C. or greater, about −90° C. or greater, about −80° C. or greater, about −70° C. or greater, about −60° C. or greater, about −50° C. or greater, about −40° C. or greater, about −30° C. or greater, about −20° C. or less, about −10° C. or less, about 0° C. or less, about 10° C. or less, about 20° C. or less, about 30° C. or less, about 40° C. or less, about 50° C. or less, or any value encompassed by these endpoints, as measures by ASTM D3418-15. For example, the first theoretical T_{g} may be about −100° C. to about 50° C., about −90° C. to about 40° C., about −30° C. to about 20° C., or about 10° C. to about 50° C., among others.

The second stage polymers may have a T_{g}, as measured using DSC, of about −50° C. or greater about −20° C. or greater, about 0° C. or greater, about 20° C. or greater, about 40° C. or greater, about 60° C. or greater, about 80° C. or greater, about 100° C. or greater, about 120° C. or less, about 140° C. or less, about 160° C. or less, about 180° C. or less, about 200° C. or less, about 220° C. or less, about 240° C. or less, about 250° C. or less, or any value encompassed by these endpoints, such as −50° C. to 250° C., 0° C. to 180° C., 10° C. to 140° C., 20° C. to 120° C. , 30° C. to 120° C., 30° C. to 80° C., 10° C. to 240° C., or 30° C. to 140° C., for example.

In some embodiments, the multistage polymer (or the multilayer particle) exhibits a single T_{g}, measured using differential scanning calorimetry (DSC), of at least −10° C. (e.g., at least −5° C., at least 0° C., at least 5° C., at least 10° C., at least 15° C., at least 20° C., at least 25° C., at least 30° C., at least 35° C., at least 40° C., at least 45° C., or at least 50° C.). In some embodiments, the multistage polymer (or the multilayer particle) exhibits a single T_{g}, measured using DSC, of 50° C. or less (e.g., 40° C. or less, 20° C. or less, 15° C. or less, 10° C. or less, or 5° C. or less).

The multistage polymer (or the multilayer particle) can exhibit a single T_{g}, measured using DSC, ranging from any of the minimum values described above to any of the maximum values described above. For example, the multistage polymer (or the multilayer particle) can exhibit a single T_{g}, measured using DSC, from —10° C. to 50° C. (e.g., from 0° C. to 40° C., or from 10° C. to 25° C.). The glass transition temperature can be determined by differential scanning calorimetry (DSC) by measuring the midpoint temperature using ASTM D 3418-12e1.

The first copolymer and the second polymer can be derived from ethylenically-unsaturated monomers. Exemplary ethylenically-unsaturated monomers include (meth)acrylate monomers, vinyl aromatic monomers (e.g., styrene), ethylenically unsaturated aliphatic monomers (e.g., butadiene), vinyl ester monomers (e.g., vinyl acetate), and combinations thereof.

In some embodiments, the first copolymer can include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

The first copolymer can be derived from one or more soft ethylenically-unsaturated monomers. As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 0° C. or less. Soft ethylenically-unsaturated monomers are known in the art, and include, for example, ethyl acrylate (T_{g}=−24° C.), n-butyl acrylate (T_{g}=−54° C.), sec-butyl acrylate (T_{g}=−26° C.), n-hexyl acrylate (T_{g}=−45° C.), n-hexyl methacrylate (T_{g}=−5° C.), 2-ethylhexyl acrylate (T_{g}=−85° C.), 2-ethylhexyl methacrylate (T_{g}=−10° C.), octyl methacrylate (T_{g}=−20° C.), n-decyl methacrylate (T_{g}=−30° C.), isodecyl acrylate (T_{g}=−55° C.), dodecyl acrylate (T_{g}=−3° C.), dodecyl methacrylate (T_{g}=−65° C.), 2-ethoxyethyl acrylate (T_{g}=−50° C.), 2-methoxy acrylate (T_{g}=−50° C.), and 2-(2-ethoxyethoxy)ethyl acrylate (T_{g}=−70° C.).

In some embodiments, the first copolymer can be derived from a soft ethylenically-unsaturated monomer that, when homopolymerized, forms a polymer having a glass transition temperature, as measured using DSC, of −10° C. or less (e.g., −20° C. or less, −30° C. or less, −40° C. or less, −50° C. or less−60° C. or less, −70° C. or less, or −80° C. or less). In certain embodiments, the soft ethylenically-unsaturated monomer can be a (meth)acrylate monomer. In certain embodiments, the first copolymer can be derived from a soft ethylenically-unsaturated monomer selected from the group consisting of n-butyl acrylate, 2-ethylhexyl acrylate, 2-ethyl acryale, 2-octyl acrylate, iso-butyl acrylate, and combinations thereof.

The first copolymer can be derived from at least 10% by weight of one or more soft ethylenically-unsaturated monomers, based on the total weight of the monomers used to form the first copolymer (e.g., at least 15% by weight, at least 20% by weight, at least 30% by weight, at least 40% by weight, or at least 50% by weight).

The first copolymer can be derived from an amount of one or more soft ethylenically-unsaturated monomers ranging from any of the percentages described above to any other of the percentages described above. For example, the first copolymer can be derived from 10% to 60% by weight of one or more soft ethylenically-unsaturated monomers, based on the total weight of the monomers used to form the first copolymer (e.g., from 60% to 97% by weight, from 100% to 60% by weight, from 40% to 99% by weight, for example).

The first copolymer can be derived from one or more phosphorus-containing monomers. Suitable phosphorous-containing monomers are known in the art, and include dihydrogen phosphate esters of alcohols in which the alcohol contains a polymerizable vinyl or olefinic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, [H₂C═C(CH₃)COO(CH₂CH₂O)ₙ]_{y}P(O)(OH)_{z}, and analogous propylene and butylene oxide condensates, where n is an integer ranging from 1 to 50, y+z=3 and y=1 or 2, z=1 or 2, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2methylpropanephosphinic acid, a-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. Phosphates of hydroxyalkyl(meth)acrylates may have the general formula [H₂C=C(R)COOCnH₂nO]_{y}P(O)(OH)_{z} where n is 2, 3 or 4; y+z=3 and y=1 or 2, z=1 or 2; R is H or CH₃. Examples of phosphate containing unsaturated monomers are Sipomer® PAM 4000, Sipomer® PAM 200, Sipomer® PAM 100, and Sipomer® PAM 600. Alkali or alkaline earth metal ion or ammonia neutralized salts of the above acids and combinations thereof can also be used.

The first copolymer can be derived from 0.1% to 5% by weight of one or more phosphorus-containing monomers, based on the total weight of the monomers used to form the first copolymer, such as about 0.1 wt. % or greater, about 0.2 wt. % or greater, about 0.5 wt. % or greater, about 0.7 wt. % or greater, about 1 wt. % or greater, about 2 wt. % or less, about 3 wt. % or less, about 4 wt. % or less, about 5 wt. % or less, or any value encompassed by these endpoints, such as about 0.1 wt. % to about 0.2 wt. %, about 0.3 wt. % to about 4 wt. %, or about 0.5 wt. % to about 2 wt. %, for example.

The first copolymer can be derived from an amount of one or more phosphorus-containing monomers ranging from any of the minimum percentages described above to any of the maximum percentages described above. For example, the first copolymer can be derived from 0.1% by weight to 5% by weight of one or more phosphorus-containing monomers, based on the total weight of the monomers used to form the first copolymer (e.g., from 0.1% by weight to 2.5% by weight of one or more phosphorus-containing monomers). In certain embodiments, the first copolymer is derived from 0.1% by weight to 5% by weight (e.g., 0.1% by weight to 3% by weight, 0.1% by weight to 2.5% by weight, or 0.1% by weight to 1.5% by weight) 2-phosphoethyl methacrylate and phospho di(ethyl methacrylate) of the general formula [H₂C═C(R)COOCH2CH2O]_{y}P(O)(OH)_{z} where y+z=3 and y=1 or 2, z=1 or 2

The first copolymer can be derived from one or more acetoacetoxy, keto or aldehyde monomers. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below CH2═CR1C(O)NR2C(O)R3 wherein R1 is hydrogen or methyl; R2 is hydrogen, a C1-C4 alkyl group, or a phenyl group; and R3 is hydrogen, a C1-C4 alkyl group, or a phenyl group. For example, the (meth)acrylamide derivative can be diacetone acrylamide (DAAM) or diacetone methacrylamide. Suitable aldehyde monomers include (meth)acrolein

The first copolymer can be derived from 0% or greater by weight of one or more acetoacetoxy monomers, keto monomers or aldehyde monomers based on the total weight of the monomers used to form the first copolymer (e.g., at least 0.3% by weight, at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, or at least 9.5% by weight). The first copolymer can be derived from 10% or less by weight of one or more acetoacetoxy monomers, keto monomers or aldehyde monomers based on the total weight of the monomers used to form the first copolymer (e.g., from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, from 0.5% or less by weight, from 0.3% or less by weight).

The first copolymer can be derived from an amount of one or more acetoacetoxy, keto or aldehyde funtional monomers ranging from any of the minimum percentages described above to any of the maximum percentages described above. For example, the first copolymer can be derived from 0% by weight to 10% by weight of one or more acetoacetoxy monomers, keto monomers, or aldehyde monomers based on the total weight of the monomers used to form the first copolymer (e.g., from 0% by weight to 7.5% by weight of one or more acetoacetoxy monomers, keto monomers, or aldehyde monomers from 2.5% by weight to 7.5% by weight of one or more acetoacetoxy monomers, keto monomers, or aldehyde monomers or from 5% by weight to 7.5% by weight of one or more acetoacetoxy monomers, keto monomers, or aldehyde monomers). In certain embodiments, the first copolymer is derived from greater than 0% by weight to 10% by weight (e.g., from 0% by weight to 7.5% by weight, from 2.5% by weight to 7.5% by weight, or from 5% by weight to 7.5% by weight) acetoacetoxyethyl (meth)acrylate (AAEM) or diacetone acrylamide.

The first stage polymer can be derived from an amount of polyamines that react with diketo groups of the acetoacetoxy monomers, keto groups of diacetone acrylamide and its derivatives and aldehyde groups of the aldehyde monomers. Polyamines with primary amines groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and Dytek. In some embodiments, amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments, amines include Dytek A, Dytek EP, Dytek HMD, Dytek BHMT, and Dytek DCH-99. In some embodiments, amines are polyhydrazides derived from aliphatic and aromatic polycarboxylic acids including adipic dihydrazide, succinic dihydrazide, citric trihydrazide, isophthalic dihydrazide, phthalic dihydrazide, trimellitic trihydrazide, etc. Other amines include diethylenetriamine, triethylenetetramine, tetraethylenepentamine, pentaethylenehexamine, hexaethyleneheptamine, heptaethyleneoctamine, 5-octaethylenenonamine, higher polyimines e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3- aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine. In some embodiments, the acetoacetoxy group, keto group or aldehyde to primary amine group ratio varies between 1:0.4 equivalents to 1:1.2 equivalents (e.g., 1:0.5 equivalents to 1:1.1 equivalents 1:0.6 equivalents to 1:1 equivalents, 1:0.7 equivalents to 1:1 equivalents 1:0.8 equivalents to 1:1 equivalents, 1:0.9 equivalents to 1:1 equivalents). For example, the acetoacetoxy group to primary amine groups ratio is 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, or 1:1.2.

The first copolymer can be derived from one or more additional crosslinking monomers which carry epoxide groups, such as glycidyl methacrylate (GMA), or monomers which carry alkoxy silane groups, such as vinyltrirthoxy silane, vinyl trimethoxy silane, (meth)acryloxy propyl triethoxy silane, and (meth)acryloxy propyl trimethoxy silane or multi-olefinically unsaturated compounds such as allyl(meth)acrylate (AMA), butanediol di(meth)acrylate, hexanediol di(meth)acrylate, and trimethylolpropane tri(meth)acrylate.

The first copolymer can be derived from one or more additional ethylenically-unsaturated monomers (e.g., carboxylic acid-containing monomers, (meth)acrylate monomers, vinyl aromatic monomers, etc.) as described below in addition to one or more soft ethylenically-unsaturated monomers, one or more phosphorus-containing monomers, and one or more acetoacetoxy monomers, keto monomers and aldehyde monomers.

In some embodiments, the first copolymer is derived from:
a. one or more soft (meth)acrylate monomers;
b. one or more carboxylic acid-containing monomers;
c. one or more acetoacetoxy monomers;
d. one or more phosphorus-containing monomers; and
e. optionally one or more additional ethylenically-unsaturated monomers, excluding monomers (a), (b), (c), and (d).

The first copolymer can be derived from at least 50% by weight of one or more additional (meth)acrylate monomers (e.g., at least 55% by weight, at least 60% by weight, at least 65% by weight, at least 70% by weight, at least 75% by weight, at least 80% by weight, at least 85% by weight, and at least 88% by weight, at least 90% by weight, at least 91% by weight, at least 92% by weight, at least 93% by weight, at least 94% by weight, at least 95% by weight, at least 99% by weight, or at least 99.9% by weight, based on the total weight of the monomers used to form the first copolymer. The (meth)acrylate monomer can include esters of α,β-monoethylenically unsaturated monocarboxylic and dicarboxylic acids having 3 to 6 carbon atoms with alkanols having 1 to 12 carbon atoms (e.g., esters of acrylic acid, methacrylic acid, maleic acid, fumaric acid, or itaconic acid, with C₁-₂₀, C₁-₈, or C₁-₄ alkanols).

Exemplary acrylate and methacrylate monomers include, but are not limited to, methyl acrylate, methyl methacrylate, ethyl acrylate, ethyl methacrylate, n-butyl acrylate, n-butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof. In some embodiments, the first copolymer is derived from one or more (meth)acrylate monomers selected from the group consisting of methyl methacrylate, n-butyl acrylate, 2-ethyl (meth)acrylate, 2-ethylhexylacrylate, 2-ethyl(meth)acrylate, iso butyl(meth)acrylate, t-butyl(meth)acrylate, and combinations thereof. In some embodiments, the first copolymer is derived from methyl methacrylate and n-butyl acrylate.

In some embodiments ethyl (meth)acrylate, iso butyl (meth)acrylate, 2-octyl (meth)acrylate, iso bornyl (methacrylate), lauryl (meth)acrylate or itaconic acid may be obtained from a bio-renewable source.

The first copolymer can be derived from one or more carboxylic acid-containing monomers based on the total weight of monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof

The first copolymer can be derived from 0% by weight or greater of one or more carboxylic acid-containing monomers, based on the total weight of the monomers used to form the first copolymer (e.g., at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight). The first copolymer can be derived from 5% or less by weight of one or more carboxylic acid-containing monomers, based on the total weight of the monomers used to form the first copolymer (e.g., from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

The first copolymer can be derived from an amount of one or more carboxylic acid-containing monomers ranging from any of the minimum percentages described above to any of the maximum percentages described above. For example, the first copolymer can be derived from 0% by weight to 5% by weight of one or more carboxylic acid-containing monomers, based on the total weight of the monomers used to form the first copolymer (e.g., from 0% by weight to 2.5% by weight of one or more carboxylic acid-containing monomers). In certain embodiments, the first copolymer is derived from 0% by weight to 5% by weight (e.g., 0% by weight to 3% by weight, 0% by weight to 2.5% by weight, or 0% by weight to 1.5% by weight) itaconic acid.

The first copolymer can be derived from 0% by weight to 35% by weight of one or more additional ethylenically-unsaturated monomers. For example, the first copolymer can further include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth)acrylamide, a (meth)acrylamide derivative, a sulfur-based monomer such as a sulfur acid monomer, or a combination of these monomers.

Suitable additional ethylenically unsaturated monomers include vinyl aromatic compounds including styrene, α- and p-methylstyrene, α-butylstyrene, 4-n-butylstyrene, 4-n-decylstyrene, vinyltoluene, and combinations thereof. Vinyl esters of carboxylic acids having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Suitable additional ethylenically unsaturated monomers include alkoxy silane monomers, for example, vinyl silanes, such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, and γ-(meth)acryloxypropyltriethoxysilane. (Meth)acrylamide derivatives include, for example, keto-containing amide functional monomers defined by the general structure below

CH₂═CR₁C(O)NR₂C(O)R₃

wherein R₁ is hydrogen or methyl; R₂ is hydrogen, a C₁-₄ alkyl group, or a phenyl group; and R₃ is hydrogen, a C₁-₄ alkyl group, or a phenyl group. For example, the (meth)acrylamide derivative can be diacetone acrylamide (DAAM) or diacetone methacrylamide. Polyhydrazides are used in combination with DAAM or diacetone methacrylamide to form crosslinked polymers. Suitable polyhydrazides are adipic dihydrazide, phthalic dihydrazide, terephthalic dihydrazide, mellitic trihydrazide, and others.

The ratio of the keto group in DAAM or diacetone methacrylamide and hydrazide group in polyhydrazide varies between 1:0.4 equivalents to 1:1.2 equivalents (e.g., 1:0.5 equivalents to 1:1.1 equivalents 1:0.6 equivalents to 1:1 equivalents, 1:0.7 equivalents to 1:1 equivalents 1:0.8 equivalents to 1:1 equivalents, 1:0.9 equivalents to 1:1 equivalents). For example, the keto group to polyhydrazide group ratio may be 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, or 1;1.2.

Sulfur-containing monomers include, for example, sulfur acids, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. When present, the sulfur-containing monomers are generally present in an amount greater than 0% by weight to 5% by weight.

In certain embodiments, the first copolymer is derived from
a. (i) 35-60% by weight n-butyl acrylate
b. (ii) 35-55% by weight methyl methacrylate
c. (iii) greater than 0 to 5% by weight itaconic acid
d. (iv) greater than 0 to 10% by weight one or more acetoacetoxy monomers and polyamine or 0 to 10% by weight one or more keto monomers and polyhydrazides; and
e. (v) greater than 0 to 5% by weight one or more phosphorus containing monomers based on the total weight of the first polymer.

In some embodiments, the second stage polymer may be formed by feeding an aqueous dispersion of low molecular weight polymer over the first stage polymer in the presence of an initiator.

The low molecular weight aqueous polymer dispersion to form the second stage polymer may have a Mn (number average molecular weight) of about 500 g/mol to about 50,000 g/mol, such as about 500 g/mol or greater, about 1000 g/mol or greater, about 1500 g/mol or greater, about 2000 g/mol or greater, about 2500 g/mol or greater, about 5000 g/mol or greater, about 7500 g/mol or greater, about 10,000 g/mol or greater, about 12,500 g/mol or greater, about 15,000 g/mol or greater, about 17,500 g/mol or greater, about 20,000 g/mol or greater, about 25,000 g/mol or greater, about 27,500 g/mol or less, about 30,000 g/mol or less, about 32,500 g/mol or less, about 35,000 g/mol or less, about 37,500 g/mol or less, about 40,000 g/mol or less, about 42,500 g/mol or less, about 45,000 g/mol or less, about 47,500 g/mol or less, about 50,000 g/mol or less, or any value encompassed by these endpoints. The low molecular weight aqueous polymer dispersions may have ethylenically unsaturated groups.

In some embodiments, the second stage polymer includes an acrylic-based polymer. Acrylic-based polymers include polymers derived from one or more (meth)acrylate monomers. The acrylic-based polymer can be a pure acrylic polymer (i.e., a polymer derived exclusively from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

In other embodiments, the second stage polymer may include a polyurethane and co-polymers thereof. Polyurethanes are typically those derived from saturated or unsaturated polyisocyanates and unsaturated and saturated polyols.

In some embodiments, the second stage polymer may be derived from:
(i) one or more hard (meth)acrylate monomers;
(ii) one or more acid -containing monomers, and
(iii) optionally one or more acetoacetoxy, keto or aldehyde monomers and a polyfunctional amine and polyhydrazide; and
(iv) optionally one or more additional ethylenically-unsaturated monomers, excluding monomers (i), (ii), and (iii).

The second stage polymer can be derived from one or more hard ethylenically-unsaturated monomers. As used herein, the term “ hard ethylenically-unsaturated monomer” refers to an ethylenically-unsaturated monomer that, when homopolymerized, forms a polymer having a T_{g}, as measured using DSC, of greater than 0° C. Hard ethylenically-unsaturated monomers are known in the art, and include, for example, methyl acrylate (T_{g}=10° C.), methyl methacrylate (T_{g}=120° C.), ethyl methacrylate (T_{g}=65° C.), butyl methacrylate (T_{g}=20° C.), tert-butyl methacrylate (T_{g}=118° C.), isobutyl methacrylate (T_{g}=53° C.), vinyl acetate (T_{g}=30° C.), hydroxyethyl acrylate (T_{g}=15° C.), hydroxyethyl methacrylate (T_{g}=57° C.), cyclohexyl acrylate (T_{g}=19° C.), cyclohexyl methacrylate (T_{g}=92° C.), 2-ethoxyethyl methacrylate (T_{g}=16° C.), 2-phenoxyethyl methacrylate (T_{g}=54° C.), benzyl acrylate (T_{g}=6° C.), benzyl methacrylate (T_{g}=54° C.), hydroxypropyl methacrylate (T_{g}=76° C.), styrene (T_{g}=100° C.), 4-acetostyrene (T_{g}=116° C.), acrylamide (T_{g}=165° C.), acrylonitrile (T_{g}=125° C.), 4-bromostyrene (T_{g}=118° C.), n-tert-butylacrylamide (T_{g}=128° C.), 4-tert-butylstyrene (T_{g}=127° C.), 2,4-dimethylstyrene (T_{g}=112° C.), 2,5-dimethylstyrene (T_{g}=143° C.), 3,5-dimethylstyrene (T_{g}=104° C.), isobornyl acrylate (T_{g}=94° C.), isobornyl methacrylate (T_{g}=110° C.), 4-methoxystyrene (T_{g}=113° C.), methylstyrene (T_{g}=20° C.), 4-methylstyrene (T_{g}=97° C.), 3-methylstyrene (T_{g}=97° C.), 2,4,6-trimethylstyrene (T_{g}=162° C.), and combinations thereof.

In some embodiments, the second stage polymer can be derived from one or more ethylenically-unsaturated monomers that, when homopolymerized, form a polymer having a T_{g}, as measured using DSC, of at least 80° C. (e.g., at least 85° C., at least 90° C., at least 95° C., at least 100° C., at least 105° C., at least 110° C., at least 115° C., or at least 120° C.).

In some embodiments, the second stage polymer can be derived from greater than 20% by weight or greater of one or more hard ethylenically-unsaturated monomers (e.g., 30% by weight or greater, 40% by weight or greater, 50% by weight or greater, 60% by weight or greater, 65% by weight or greater, 75% by weight or greater, 80% by weight or greater, 85% by weight or greater, 88% by weight or greater, 90% by weight or greater, 91% by weight or greater, 92% by weight or greater, 93% by weight or greater, 94% by weight or greater, or 95% by weight or greater of the ethylenically-unsaturated monomer) based on the total weight of monomers used to form the second stage polymer.

In some embodiments, the second stage polymer can be derived from one or more ethylenically-unsaturated monomers selected from the group consisting of methyl (meth)acrylate, 2-ethyl(meth)acrylate, n-butyl(meth)acrylate, i-butyl (meth)acrylate, t-butyl(meth)acrylate, cyclohexyl(meth)acrylate, 2-ethylhexyl (meth)acrylate, i-bornyl(meth)acrylate, styrene, (meth)acrylic acid and combinations thereof. In certain embodiments, the second stage polymer is derived from at least 10% by weight (e.g., at least 10% by weight, at least 20% by weight, at least 30% by weight, at least 40% by weight, at least 50% by weight, at least 60% by weight, at least 70% by weight, at least 80% by weight, at least 90% by weight, at least 92% by weight, at least 95% by weight, at least 96% by weight, at least 97% by weight, or at least 98% by weight) of one or more ethylenically-unsaturated monomers selected from the group consisting of methyl (meth)acrylate, 2-ethyl(meth)acrylate, n-butyl (meth)acrylate, i-butyl (meth)acrylate, t-Butyl(meth)acrylate, cyclohexyl(meth)acrylate, 2-ethylhexyl (meth)acrylate, i-bornyl(meth)acrylate, styrene, (meth)acrylic acid and combinations thereof, based on the total weight of monomers used to form the second stage polymer.

In addition to the ethylenically-unsaturated monomers, the second stage polymer may be derived from one or more ethylenically unsaturated acid monomers.

In certain embodiments, the second stage polymer is derived from at least 2% by weight, at least 5% by weight, at least 7% by weight, at least 10% by weight, at least 13% by weight, at least 15% by weight, at least 17% by weight, or at least 20% by weight of one or more ethylenically-unsaturated acid monomers, based on the total weight of monomers used to form the second stage polymer. The acid value of these polymers may be (measured by titration with KOH) from 40 to 250 mg KOH/g of the polymer.

Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof. The second stage copolymer can be derived from 2% by weight or greater of one or more carboxylic acid-containing monomers, based on the total weight of the monomers used to form the second stage copolymer (e.g., at least 2.0% by weight, at least 3% by weight, at least 4% by weight, at least 5% by weight, at least 6% by weight, at least 8% by weight, at least 10% by weight, at least 13% by weight, or at least 15% by weight). The second stage copolymer can be derived from 20% or less by weight of one or more carboxylic acid-containing monomers, based on the total weight of the monomers used to form the first copolymer (e.g., from 15% or less by weight, from 13% or less by weight, from 10% or less by weight, from 8% or less by weight, from 6% or less by weight, from 5% or less by weight, from 4% or less by weight, from 3% or less by weight).

The second stage copolymer can be derived from an amount of one or more carboxylic acid-containing monomers ranging from any of the minimum percentages described above to any of the maximum percentages described above. For example, the second stage copolymer can be derived from 2% by weight to 20% by weight of one or more carboxylic acid-containing monomers, based on the total weight of the monomers used to form the second stage copolymer (e.g., from 2% by weight to 20% by weight of one or more carboxylic acid-containing monomers). In certain embodiments, the second stage copolymer is derived from 2% by weight to 20% by weight (e.g., 2% by weight to 6% by weight, 5% by weight to 10% by weight, or 8% by weight to 20% by weight, or 10% by weight to 20% by weight) acrylic acid or methacrylic acid.

The second stage polymer can be derived from one or more additional ethylenically-unsaturated monomers (e.g., (meth)acrylate monomers, vinyl aromatic monomers, vinyl acetate monomers, keto monomers, phosphorus-containing monomers, such as those described above for first stage polymer, in addition to one or more hard ethylenically-unsaturated monomers and carboxylic acid monomers.

The second polymer is formed by high temperature polymerization as described in U.S. Pat. Nos. 4,414,370, 4,529,787, 4,546,160, 6,552,144, 8,785,548 followed by dispersion into water and then feeding over the first polymer along with initiator.

The second stage polymer may further comprise a self-crosslinker selected from the group consisting of a combination of keto monomers and polyhydrazides. Keto monomers include, for example, keto-containing amide functional monomers defined by the general structure below

CH₂═CR₁C(O)NR₂C(O)R₃

wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM) or diacetone methacrylamide. Polyhydrazides are used in combination with DAAM or diacetone methacrylamide to form crosslinked polymers. Suitable polyhydrazides are adipic dihydrazide, phthalic dihydrazide, terephthalic dihydrazide, mellitic trihydrazide, and others.

The ratio of the keto group in DAAM or diacetone methacrylamide and hydrazide group in polyhydrazide varies between 1:0.4 equivalents to 1:1.2 equivalents (e.g., 1:0.5 equivalents to 1:1.1 equivalents 1:0.6 equivalents to 1:1 equivalents, 1:0.7 equivalents to 1:1 equivalents 1:0.8 equivalents to 1:1 equivalents, 1:0.9 equivalents to 1:1 equivalents). For example, the keto group to polyhydrazide group ratio may be 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, or 1;1.2.

The second stagecopolymer can be derived from one or more crosslinking monomers which carry epoxide groups, such as glycidyl methacrylate (GMA), or monomers which carry alkoxy silane groups, such as vinyltrirthoxy silane, vinyl trimethoxy silane, (meth)acryloxy propyl triethoxy silane, and (meth)acryloxy propyl trimethoxy silane or multiolefinically unsaturated compounds such as allyl(meth)acrylate (AMA), butanediol di(meth)acrylate, hexanediol di(meth)acrylate, and trimethylolpropane tri(meth)acrylate.

The weight ratio of the first stage copolymer to the second stage copolymer in the multistage particle may be in a range of from about 50:50 or greater, about 60:40 or greater, about 70:30 or greater, about 80:20 or greater, about 90:10 or greater, about 95:5 or greater, about 97.5:2.5 or greater, or any value encompassed by these endpoints.

The second stage copolymer may be present in the multistage particle in an amount of about 2.5 wt. % or greater, about 5 wt. % or greater, about 10 wt. % or greater, about 15 wt. % or greater, about 20 wt. % or less, about 25 wt. % or less, about 30 wt. % or less, about 35 wt. % or less, about 40 wt. % or less, or any value encompassed by these endpoints, such as about 2.5 wt. % to about 40 wt. %, about 10 wt. % to about 25 wt. %, about 5 wt. % to about 15 wt. %, or about 35 wt. % to about 40 wt. %, for example, based on the total particle weight. In another embodiment, the low molecular weight polymer in water may be mixed with ethylenically unsaturated monomers and polymerized over the first layer polymer. The ethylenically unsaturated monomers include (meth)acrylate monomers, vinyl aromatic monomers (e.g., styrene), vinyl ester monomers (e.g., vinyl acetate), and combinations thereof. Details of these monomers are disclosed in the previous sections for first stage monomers. In some embodiments, the ethylenically unsaturated monomers do not include acid monomers. In some embodiments second stage monomer and low molecular weight polymer mixture to form the second stage polymer is substantially free of surfactants.

In some embodiments, the ratio between low molecular weight polymer to ethylenically unsaturated monomers can be 97.5 :2.5 to 30:70. Any ratio between these two ratios can be used such as 95:5, 90:10, 80:20, 70:30, 60:40, 50:50, 40:60, 30:70. The theoretically calculated Tg of the copolymers formed by the ethylenically unsaturated monomers mixed with low molecular weight polymer may have a T_{g}, as measured using DSC, of about −50° C. or greater about −20° C. or greater, about 0° C. or greater, about 20° C. or greater, about 40° C. or greater, about 60° C. or greater, about 80° C. or greater, about 100° C. or greater, about 120° C. or less, about 140° C. or less, about 160° C. or less, about 180° C. or less, about 200° C. or less, about 220° C. or less, about 240° C. or less, about 250° C. or less, or any value encompassed by these endpoints, such as −50° C. to 250° C., 0° C. to 180° C., 10° C. to 140° C., 20° C. to 120° C. , 30° C. to 120° C., 30° C. to 80° C., 10° C. to 240° C., or 30° C. to 140° C., for example.

In certain embodiments, the second copolymer may be derived from
(i) 35-60% by weight methyl(meth)acrylate, t-butyl (meth)acrylate, i-butyl methacrylate, styrene, cyclohexyl(meth)acrylate, n-butyl-(meth)acrylate, 2-ethyl(meth)acrylate or combinations there of
(ii) greater than 2 to 15% by weight one or more carboxylic acid containing monomers;
(iii) and greater than 0 to 10% by weight one or more acetoacetoxy, keto or aldehyde monomers and a polyfunctional amine and polyhydrazides, and
(iv) optionally one or more additional ethylenically-unsaturated monomers, excluding monomers (i), (ii), and (iii).

Also provided are aqueous compositions comprising one or more of the multistage polymers (or multilayer particles) described above. The aqueous compositions can further include one or more additives, including pigments, fillers, dispersants, coalescents, pH modifying agents, plasticizers, defoamers, surfactants, thickeners, biocides, co-solvents, and combinations thereof. The choice of additives in the composition will be influenced by a number of factors, including the nature of the multistage polymers (or multilayer particles) dispersed in the aqueous composition, as well as the intended use of the composition. In some cases, the composition can be, for example, a coating composition, such as a paint, a primer, or a paint-and-primer-in-one formulation. In some embodiments, the composition comprises less than or equal to 50 grams per liter of volatile organic compounds.

The aqueous composition may comprise greater than 40% solids, such as about 40% or greater, about 50% or greater, about 55% or greater, about 60% or greater, about 65% or greater, or about 70% or greater.

In some embodiments, the aqueous composition can further comprise an aryl phosphate surfactant. The composition can include 0% by weight or greater of one or more aryl phosphate surfactants, based on the total weight of all components of the aqueous composition (e.g., 0% by weight, at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, or at least 9.5% by weight). The composition can include 10% or less of one or more aryl phosphate surfactants, based on the total weight of all components of the aqueous composition (e.g., from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

The composition can include one or more aryl phosphate surfactants in an amount ranging from any of the minimum percentages described above to any of the maximum percentages described above. For example, the composition can include from 0% by weight to 10% by weight of one or more aryl phosphate surfactants, based on the total weight of all components of the aqueous composition (e.g., from 0% by weight to 3% by weight of one or more aryl phosphate surfactants, from 0% by weight to 2.5% by weight of one or more aryl phosphate surfactants, from 0% by weight to 1.5% by weight of one or more aryl phosphate surfactants, or 0% by weight to 1% by weight of one or more aryl phosphate surfactants). In some embodiments, the composition is substantially free (i.e., the composition includes 0.1% or less by weight) of aryl phosphate surfactants.

In certain embodiments, the aryl phosphate surfactant can comprise a tristyrylphenol alkoxylated phosphate. Suitable tristyrylphenol alkoxylated phosphates include surfactants defined by Formula I below

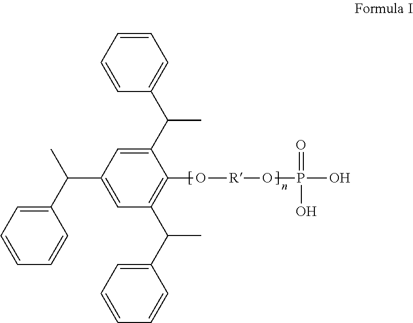

or a salt thereof, wherein R′ comprises a C₁-C₆ alkylene group, and n is an integer ranging from 1 to 50 (e.g., from 1 to 25, or from 10 to 20). In certain embodiments, the aqueous composition comprises a tristyrylphenol alkoxylated phosphate defined by Formula I or a salt thereof, wherein R′ comprises an ethylene group, and n is an integer ranging from 10 to 20. In certain embodiments, the aqueous composition includes the tristyrylphenol alkoxylated phosphate shown below in Formula II

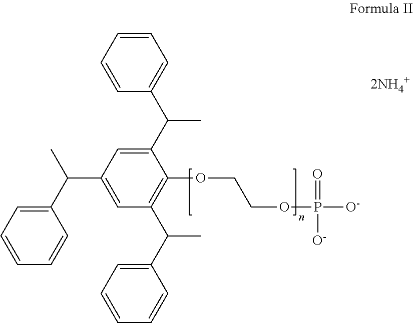

wherein n is 16.

Examples of suitable pigments include metal oxides, such as titanium dioxide, zinc oxide, iron oxide, or combinations thereof. In certain embodiments, the composition includes a titanium dioxide pigment. Examples of commercially titanium dioxide pigments are KRONOS® 2101, KRONOS® 2310, available from Kronos WorldWide, Inc. (Cranbury, N.J.), TI-PURE® R-900, available from DuPont (Wilmington, Del.), or TIONA® AT1 commercially available from Millenium Inorganic Chemicals. Titanium dioxide is also available in concentrated dispersion form. An example of a titanium dioxide dispersion is KRONOS® 4311, also available from Kronos WorldWide, Inc.

Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a carboxylic acid copolymer-type dispersing agent, such as Dispex CX 4240, commercially available from BASF SE.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Examples of suitable pH modifying agents include amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Defoamers serve to minimize frothing during mixing and/or application of the coating composition. Suitable defoamers include silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.).

Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include 2-[(hydroxymethyl)amino] ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers include ethylene glycol, propylene glycol, diethylene glycol, and combinations thereof.

Other suitable additives that can optionally be incorporated into the composition include rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, insecticides, lubricants, odorants, oils, waxes and slip aids, soil repellants, stain resisting agents, and combinations thereof.

Coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating compositions can be applied to a variety of surfaces including, but not limited to metal, asphalt, concrete, stone, ceramic, wood, plastic, polyurethane foam, glass, wall board coverings (e.g., drywall, cement board, etc.), and combinations thereof. The coating compositions can be applied to interior or exterior surfaces. In certain embodiments, the surface is an architectural surface, such as a roof, wall, floor, or combination thereof. The architectural surface can be located above ground, below ground, or combinations thereof

Also provided are coatings formed from the coating compositions described herein. Generally, coatings are formed by applying a coating composition described herein to a surface, and allowing the coating to dry to form a coating. The coating thickness can vary depending upon the application of the coating.

Also provided are methods of making the multistage polymers and multilayer particles described above. The first layer of the multistage polymers and multilayer particles described above can be prepared by heterophase polymerization techniques, such as free-radical emulsion polymerization, suspension polymerization, and mini-emulsion polymerization, for example. In some examples, the first layer multistage polymer is prepared by polymerizing the monomers using free-radical emulsion polymerization. The emulsion polymerization temperature can be about 10° C. or higher, about 20° C. or higher, about 30° C. or higher, about 40° C. or higher, about 50° C. or higher, about 60° C. or higher, about 70° C. or lower, about 80° C. or lower, about 90° C. or lower, about 95° C. or lower, about 100° C. or lower, or any value encompassed by these values.

The emulsion polymerization medium can include water alone or a mixture of water and water-miscible liquids, such as methanol, ethanol or tetrahydrofuran. In some embodiments, the polymerization medium is free of organic solvents and includes only water.

The emulsion polymerization can be carried out as a batch process, as a semi-batch process, or in the form of a continuous process. In some embodiments, a portion of the monomers can be heated to the polymerization temperature and partially polymerized, and the remainder of the monomer batch can be subsequently fed to the polymerization zone continuously, in steps, or with superposition of a concentration gradient.

To produce the multilayer particle, the second stage copolymer may be used to form a second layer over the first layer. The second stage copolymer may be formed separately using a high temperature polymerization process in a continuous stirred tank reactor as described in U.S. Pat. Nos. 4,414,370, 4,546,160, 6,552,144, 8,785,548. The temperature during the high temperature polymerization process may be about 120° C. or greater, such as about 150° C. or greater, about 175° C. or greater, about 200° C. or greater, about 225° C. or greater, or about 250° C. or greater. These preformed low molecular weight polymers are dispersed into water and fed on to first stage polymer in the presence of a free radical polymerization initiator to form the second layer (second stage).

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 10% or 0.5% to 5% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethylacrylic esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

Dispersants, such as surfactants, can also be added during polymerization to help maintain the dispersion of the monomers in the aqueous medium. For example, the polymerization can include less than 3% by weight or less than 1% by weight of surfactants. In some embodiments, the polymerization is substantially free of surfactants and can include less than 0.05% or less than 0.01% by weight of one or more surfactants. In other embodiments, the first emulsion polymerization step and/or the second polymerization step further comprise an aryl phosphate surfactant. (e.g., a tristyrylphenol alkoxylated phosphate surfactant, Formula I and its salts, Formula II).

Anionic and nonionic surfactants can be used during polymerization. Suitable surfactants include ethoxylated C₈ to C₃₆ or C₁₂ to C₁₈ fatty alcohols having a degree of ethoxylation of 3 to 50 or of 4 to 30, ethoxylated mono-, di-, and tri-C₄ to C₁₂ or C₄ to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids.

In one embodiment, the multilayer particles presented herein may be produced by a method comprising:
a) producing a first layer comprising a first polymer by emulsion polymerization;
b) producing a second polymer by high temperature polymerization;
c) forming an aqueous solution comprising the second polymer; and
d) feeding the aqueous solution comprising the second polymer on to the first layer in the presence of a free-radical polymerization initiator.

In another embodiment, the multilayer particles presented herein may be produced by a method comprising:
a) producing a first layer comprising a first polymer by emulsion polymerization;
b) producing a second polymer by high temperature polymerization;
c) forming an aqueous solution comprising the second polymer and ethylenically unsaturated monomers; and
d) feeding the aqueous solution comprising the second polymer and ethylenically unsaturated monomer on to the first layer in the presence of a free-radical polymerization initiator. Step d may be conducted at a temperature of about 70° C. or lower, about 75° C. or lower, about 80° C. or lower, about 90° C. or lower, or about 95° C. or lower.
In an embodiment, steps c may be substantially free of surfactants. By “substantially free”, it is understood that the aqueous solutions of step c include surfactants in an amount of less than 0.1 wt. %, as a percentage of the total reaction mixture.

When producing the multilayer particles of the present disclosure, the weight ratio the first stage (or first layer) to the second stage (or second layer) can be about 50:50 or greater, about 55:45 or greater, about 60:40 or greater, about 70:30 or greater, about 75:25 or greater, about 80:20 or less, about 85:15 or less, about 90:10 or less, about 95:5 or less, about 97.5:2.5 or less, or any value encompassed by these endpoints. For example, the weight ratio may be about 50:50 to about 97.5:2.5, about 75:25 to about 85:15, about 80:20 to about 90:10, about 95:5 to about 97.5:2.5, among others.

Paints formulated using the multistage particles of the present invention may display good gloss, tint strength, and stain resistance. The acid content in the second copolymer may also be varied.

By way of non-limiting illustration, examples of certain embodiments of the present disclosure are given below.

### EXAMPLES

### Test Methods

Tint strength was measured by tinting coating formulations with identical amounts of tint paste. In these experiments 100 grams of paint was mixed with 1.16 grams of Pure Options® black colorant BL. A 3 mil film of each coating formulation was drawn down and dried for 24 hours at 25° C. and 50% relative humidity. Then the tint strength was measured using spectrophotometer in comparison to a standard which is set to a tint strength of 100%. Higher tint strength indicates higher light scattering by the coating and higher values are preferred.

The stain resistance testing of coating formulations was carried out according to a modified ASTM D 4828-94 (2012). ASTM D 4828-94(2012) is entitled “Standard Test Methods for Practical Washability of Organic Coatings,” and is incorporated herein by reference in its entirety. The test measured the degree of removal of stains applied to a dried coating. A 7 mil film of flat white base formulation was applied to a Leneta Black Scrub Panel. After 7 days of curing at 25° C. and 50% relative humidity, a series of “stains” (mustard, hot coffee, red wine, pencil, purple crayon, ketchup, black ballpoint pen, lipstick, Lenetta ST-1) were applied on top of the painted panel. After one hour, excess stain material was gently washed off and blotted dry. Panels were then scrubbed for 50 cycles with a sponge and 10 cc of Leneta SC-1 (Standardized Scrub Medium Non-Abrasive type). Once dried, samples were rated for stain removal as described in ASTM D 4828-94 (2012) but with a modification to the scale to include intermediate numbers so as to differentiate the degree of stain removal among samples.

Gloss values of the coatings were measured according to the ASTM D523 test method.

### Example 1: Synthesis of Multilayer Particles with High and Low Molecular Weight Polymers

A polymerization vessel equipped with metering devices and temperature regulation was charged under a nitrogen atmosphere at 20° to 25° C. (room temperature) with initial charge. The mixture was heated to 85° C. with stirring. When the set temperature was reached, 7% of Feed 1 was added and the mixture was stirred for 5 minutes prior to commencing feeds 1 and 2. Feed 1 was metered in over 3.2 hours, and feed 2 over 2.05 hours. Ten minutes after the end of feed 2, feed 3 was added over 60 minutes. Ten minutes after completing feed 3, the temperature was reduced to 80° C. and feed 4 was added. Feeds 5 and 6 were then metered in over 60 minutes in parallel. Twelve minutes after the end of these feeds, the batch was cooled to less than 40° C. Feed 7 was then added over 5 minutes, followed by feed 8 over 20 minutes in cases where the recipe had feed 8. The batch was mixed for 5 minutes and filtered. The weight percentage of solids, pH, and viscosity were measured.

Representative examples of polymer dispersions prepared using this procedure are provided in Table 1, which shows Runs 1, 2, 3, and 4.

TABLE 1

| | Component | Run 1 | Run 2 | Run 3 | Run 4 |
|---|---|---|---|---|---|
| Initial | Water | 374.3 | 327.3 | 335.1 | 217.9 |
| Charge | Polystyrene seed | 53.7 | 52.1 | 53.4 | 36.22 |
| | (32% in water) | | | | |
| Feed 1 | Water | 28.8 | 28 | 28.6 | 19.4 |
| | Sodium | 1.8 | 1.8 | 1.9 | 1.26 |
| | Persulfate | | | | |
| Feed 2 | Water | 201.6 | 168.6 | 172.6 | 78.6 |
| | TSPAP | 37.1 | 36 | 36.9 | 22.3 |
| | surfactant* | | | | |
| | Hydropalat | 5.2 | 5 | 5.1 | 3.1 |
| | WE 3320 | | | | |
| | Sipomer | 9.3 | 9.1 | 9.3 | 5.6 |
| | PAM 4000 | | | | |
| | n-Butyl acrylate | 405.7 | 380.5 | 389.5 | 243.3 |
| | Methyl | 423.5 | 380 | 389.1 | 255 |
| | methacrylate | | | | |
| | Tertiary dodecyl | 0.9 | 0.9 | 0.9 | 0.56 |
| | mercaptan | | | | |
| | 19% Aqueous | 4.9 | 4.8 | 4.9 | 2.95 |
| | ammonium | | | | |
| | hydroxide | | | | |
| Feed 3 | Water | 106.2 | 175.5 | 179.7 | 105.2 |
| | LMWP-1D** | 295.5 | 287 | 293.9 | 398.7 |
| | n-Butyl acrylate | 0 | 14.1 | 14.4 | 0 |
| | Methyl | 0 | 28.1 | 31.1 | 0 |
| | methacrylate | | | | |
| | Styrene | 0 | 2.3 | 2.3 | 0 |
| | Acetoacetylethyl | 0 | 2.3 | 0 | 0 |
| | methacrylate | | | | |
| Feed 4 | Rhodaline 635 | 0.9 | 0.9 | 0.9 | 0.6 |
| Feed 5 | Water | 14.7 | 14.3 | 14.6 | 9.9 |
| | Aqueous t-butyl | 0.8 | 0.8 | 0.8 | 0.54 |
| | hydroperoxide | | | | |
| | (70%) | | | | |
| Feed 6 | Water | 14.6 | 14.1 | 14.2 | 9.8 |
| | Sodium | 0.9 | 0.9 | 0.9 | 0.63 |
| | metabisulfite | | | | |
| Feed 7 | Water | 15.3 | 8.3 | 8.5 | 5.8 |
| | 19% aqueous | 0.98 | 0.95 | 0.98 | 0.66 |
| | ammonium | | | | |
| | hydroxide | | | | |
| Feed 8 | Water | 0 | 45.3 | 0 | 0 |
| | Baxxodur | 0 | 1.2 | 0 | 0 |
| | EC 310 | | | | |
| % solids | 48.7 | 47.3 | 46.9 | 47.1 | 45.2 |
| pH | 6.9 | 6.9 | 6.8 | 6.1 | 6.9 |
| Viscosity, | 55 | 56 | 45.6 | 63 | 36.8 |
| #2 LV | | | | | |
| spindle, | | | | | |
| 50 rpm, | | | | | |
| cPS | | | | | |

*Tristyrylphenol alkoxylated phosphate surfactant (26.4 weight % in water)
**See Table 5

Further examples of polymer dispersions prepared using the procedure described above are provided in Table 2, which shows results from Runs 5, 6, 7, and 8.

TABLE 2

| | Component | Run 5 | Run 6 | Run 7 | Run 8 |
|---|---|---|---|---|---|
| Initial | Water | 212.4 | 318.7 | 368.3 | 219.5 |
| Charge | Polystyrene seed | 34.2 | 52.2 | 52.8 | 32.3 |
| | (32% in water) | | | | |
| Feed 1 | Water | 18.4 | 28 | 28.3 | 17.3 |
| | Sodium Persulfate | 1.2 | 1.8 | 1.8 | 1.12 |
| Feed 2 | Water | 68.5 | 136 | 198.4 | 110.6 |
| | TSPAP surfactant* | 21.1 | 32.1 | 36.5 | 23.6 |
| | Hydropalat | 2.95 | 4.5 | 5.1 | 3.3 |
| | WE 3320 | | | | |
| | Sipomer PAM 4000 | 5.3 | 8.1 | 9.2 | 5.95 |
| | n-Butyl acrylate | 230.5 | 350.8 | 399.2 | 249.5 |
| | Methyl methacrylate | 241.7 | 367.7 | 418.5 | 250.1 |
| | Tertiary dodecyl | 0.5 | 0.8 | 0.9 | 0.6 |
| | mercaptan | | | | |
| | 19% Aqueous | 2.8 | 4.2 | 4.8 | 3.1 |
| | ammonium | | | | |
| | hydroxide | | | | |
| Feed 3 | Water | 115.7 | 53.1 | 126.1 | 104.4 |
| | LMWP-3D** | 0 | 591.7 | 299.3 | 0 |
| | LMWP-2D** | 361.7 | 0 | 0 | 0 |
| | LMWP-4D** | 0 | 0 | 0 | 165.2 |
| Feed 4 | Rhodaline 635 | 0.6 | 0.9 | 0.9 | 0.56 |
| Feed 5 | Water | 9.4 | 14.3 | 14.5 | 8.84 |
| | Aqueous t-butyl | 0.5 | 0.8 | 0.8 | 0.48 |
| | hydroperoxide | | | | |
| | (70%) | | | | |
| Feed 6 | Water | 9.3 | 14.2 | 14.3 | 8.7 |
| | Sodium | 0.6 | 0.9 | 0.9 | 0.56 |
| | metabisulfite | | | | |
| Feed 7 | Water | 5.5 | 8.3 | 8.3 | 27.6 |
| | 19% aqueous | 0.63 | 1 | 1 | 0.6 |
| | ammonium | | | | |
| | hydroxide | | | | |

| | | | | |
|---|---|---|---|---|
| % solids | 45.8 | 46.1 | 48.4 | 47.3 |
| pH | 6.8 | 7.9 | 6.6 | 6.8 |
| Viscosity, #2 LV | 29.8 | 17.6 | 56.8 | 45.6 |
| spindle, 50 rpm, cPS | | | | |

*Tristyrylphenol alkoxylated phosphate surfactant (26.4 weight % in water)
**See Table 5

Further examples of polymer dispersions prepared using the procedure described above are provided in Table 3, which shows results from Runs 9, 10, and 11, as well as Comparative Example 1.

TABLE 3

| | | | | | Comparative |
|---|---|---|---|---|---|
| | Component | Run 9 | Run 10 | Run 11 | Example 1 |
| Initial | Water | 335.1 | 294.6 | 292.9 | 518.8 |
| Charge | Polystyrene | 53.4 | 46.9 | 46.7 | 62 |
| | seed (32% in | | | | |
| | water) | | | | |
| Feed 1 | Water | 28.7 | 25.2 | 25 | 33.3 |
| | Sodium | 1.9 | 1.6 | 1.6 | 2.16 |
| | Persulfate | | | | |
| Feed 2 | Water | 172.6 | 151.7 | 133.1 | 232.9 |
| | TSPAP | 36.9 | 32.4 | 28.5 | 42.9 |
| | surfactant* | | | | |
| | Hydropalat | 5.1 | 4.5 | 4 | 6 |
| | WE 3320 | | | | |
| | Sipomer | 9.3 | 8.2 | 7.2 | 10.8 |
| | PAM 4000 | | | | |
| | n-Butyl | 389.5 | 342.4 | 300.4 | 469.7 |
| | acrylate | | | | |
| | Methyl | 389 | 342 | 299 | 489.3 |
| | methacrylate | | | | |
| | Tertiary | 0.9 | 0.8 | 0.72 | 1.1 |
| | dodecyl | | | | |
| | mercaptan | | | | |
| | 19% Aqueous | 4.9 | 4.3 | 3.8 | 5.7 |
| | ammonium | | | | |
| | hydroxide | | | | |
| Feed 3 | Water | 200.6 | 176.2 | 102.6 | 0 |
| | LMWP-4D** | 273.1 | 240.1 | 397.8 | 0 |
| | Methyl | 31.1 | 25.3 | 41.9 | 0 |
| | methacrylate | | | | |
| | Styrene | 2.3 | 2 | 3.4 | 0 |
| | n-Butyl | 14.4 | 12.6 | 21 | 0 |
| | acrylate | | | | |
| | Acetoacetoxy | 0 | 2 | 3.4 | 0 |
| | ethyl | | | | |
| | methacrylate | | | | |
| Feed 4 | Rhodaline 635 | 0.9 | 0.8 | 0.8 | 1.1 |
| Feed 5 | Water | 14.6 | 12.85 | 12.8 | 17.9 |
| | Aqueous t- | 0.8 | 0.7 | 0.7 | 0.93 |
| | butyl | | | | |
| | hydroperoxide | | | | |
| | (70%) | | | | |
| Feed 6 | Water | 14.5 | 12.7 | 12.7 | 16.85 |
| | Sodium | 0.93 | 0.8 | 0.8 | 1.1 |
| | metabisulfite | | | | |
| Feed 7 | Water | 8.5 | 7.5 | 7.4 | 31.4 |
| | 19% aqueous | 0.98 | 0.86 | 0.85 | 1.14 |
| | ammonium | | | | |
| | hydroxide | | | | |
| Feed 8 | Water | 0 | 40.8 | 40.6 | 0 |
| | Baxxodur | 0 | 1.1 | 1.8 | 0 |
| | EC 310 | | | | |

| | | | | |
|---|---|---|---|---|
| % Weight solids | 46.4 | 50.8 | 46.1 | 50.8 |
| pH | 6.7 | 7 | 7.9 | 7.1 |
| Viscosity, #2 LV | 50.4 | 25.6 | 17.6 | 360 |
| spindle, 50 rpm, cPS | | | | |

*Tristyrylphenol alkoxylated phosphate surfactant (26.4 weight % in water)
**See Table 5

### Example 2: Synthesis of Low Molecular Weight Polymers at High Temperatures

The low molecular weight polymers are synthesized as described in U.S. Pat. Nos. 4,414,370 and 8,785,548, which are incorporated herein by references in its entirety. The components and characteristics of four low molecular weight polymers (LMWP-1, LMWP-2, LMWP-3, and LMWP-4) are shown below in Table 4.

TABLE 4

| Ingredients | LMWP-1 | LMWP-2 | LMWP-3 | LMWP-4 |
|---|---|---|---|---|
| Acrylic acid | 9.98 | 9.7 | 5.8 | 9.98 |
| Ethyl acrylate | 20.70 | 49.4 | 49.4 | 50.2 |
| Methyl methacrylate | 56.70 | 28.5 | 32.3 | 39.6 |
| Styrene | 12.40 | 12.3 | 12.3 | 0 |
| n-Butyl acrylate | 0.00 | 0.0 | 0.0 | 0 |
| Di(tertiary amyl) | 0.20 | 0.20 | 0.20 | 0.20 |
| peroxide | | | | |
| Number average | 5404 | 5451 | 5367 | 4849 |
| molecular weight (Mn), | | | | |
| kDa | | | | |
| Weight Average | 15718 | 19735 | 18412 | 16977 |
| molecular weight (Mw), | | | | |
| kDa | | | | |
| Acid Value (mg | 80.3 | 78.2 | 48.0 | 79.3 |
| KOH/g) | | | | |

### Example 3: Aqueous Dispersions of Low Molecular Weight Polymers

Aqueous dispersion of the low molecular weight polymers (LMWP-1, LMWP-2, LMWP-3, and LMWP-4) described above were prepared by dispersing above polymers in water using ammonium hydroxide as a neutralizing agent to obtain the corresponding polymer dispersions shown in Table 5 (LMWP-1D, LMWP-2D, LMWP-3D, and LMWP-4D).

TABLE 5

| | LMWP- | LMWP- | LMWP- | LMWP- |
|---|---|---|---|---|
| Component | 1D | 2D | 3D | 4D |
| LMWP-1 | 32 | 0 | 0 | 0 |
| LMWP-2 | 0 | 30 | 0 | 0 |
| LMWP-3 | 0 | 0 | 31 | 0 |
| LMWP-4 | 0 | 0 | 0 | 32 |
| Water | 64.5 | 66.6 | 66.1 | 64.2 |
| Aqueous ammonia (28%) | 3.5 | 3.4 | 2.9 | 3.8 |
| % solids | 31.6 | 29.9 | 30.7 | 31.5 |
| pH | 7.05 | 7.04 | 8.3 | 6.9 |

### Example 4: Semigloss Paint Formulations using the Polymers of the Present Disclosure

Semigloss paints were formulated using the polymers of the present disclosure (Runs 1-11, described above) and a comparative polymer (Comparative Example 1, described above). The paints further comprised the components shown below in Table 6.

TABLE 6

| Components | Grams |
|---|---|
| Water | 176.7 |
| Proxel BD 20 | 3.0 |
| Ammonium Hydroxide (28%) | 1.0 |
| Dispex CX 4240 | 5.0 |
| FoamStar ST 2420 | 3.0 |
| ASP G 90 | 30.0 |
| Attagel 50 | 2.0 |
| Hydropalat WE 3320 | 4.0 |
| Texanol | 14.0 |
| Optifilm 400 | 4.0 |
| Kronos 4311 | 280.0 |
| Aquaflow NHS-310 | 32.0 |
| Polymer | 483.9* |
| Polyphase 678 | 6.0 |
| Acrysol RM8W | 5.0 |
| Total Weight | 1049.6 |

*46.5% solids polymer dispersion; adjusted based on actual % solids to get 225 grams of solid polymer

Paint formulations were tested for gloss, tint strength and stain resistance using the test methods described above. The results are given in Tables 7 and 8.

TABLE 7

| Run # | 1 | 2 | 3 | 4 | 5 | 6 | 7 | 8 | 9 | 10 | 11 | **CA 1 |
|---|---|---|---|---|---|---|---|---|---|---|---|---|
| Gloss | | | | | | | | | | | | |
| 20° | 16.6 | 21.8 | 23.5 | 27.6 | 30.6 | 30.8 | 18.4 | 28.4 | 23.9 | 25.6 | 31 | 7.4 |
| 60° | 55.8 | 59.9 | 61 | 66.1 | 67.5 | 67.8 | 57.5 | 66 | 61 | 64.8 | 67.6 | 47.6 |
| 85º | 86.9 | 87.3 | 86.9 | 89.6 | 89.5 | 90.6 | 86.5 | 89.4 | 87.7 | 90.5 | 87.4 | 85.6 |
| Tint | 90.7 | 101.5 | 102.9 | 94.1 | 105.5 | 111 | 92.4 | 95.9 | 104.9 | 106 | 110 | 98.1 |
| strength | | | | | | | | | | | | |
| (%) * | | | | | | | | | | | | |

* compared to a commercial polymer for which tint strength is set to 100%;
**Comparative Example 1

TABLE 8
Stain resistance rating (0-10)

| Run # | 1 | 2 | 3 | 4 | 5 | 6 | 7 | 8 | 9 | 10 | 11 | *CA 1 |
|---|---|---|---|---|---|---|---|---|---|---|---|---|
| Pencil | 3 | 7 | 4 | 2 | 3 | 5 | 5 | 5 | 5 | 7 | 3 | 2 |
| Purple Crayon | 7 | 7 | 8 | 4 | 4 | 8 | 7 | 6 | 7 | 8 | 6 | 3 |
| Black ballpoint pen | 3 | 3 | 3 | 6 | 5 | 5 | 3 | 3 | 3 | 7 | 5 | 5 |
| Hot passion 305 lipstick | 6 | 7 | 7 | 7 | 8 | 8 | 10 | 5 | 7 | 6 | 7 | 3 |
| French's classic mustard | 5 | 5 | 5 | 5 | 7 | 7 | 6 | 5 | 5 | 6 | 7 | 3 |
| Ketchup | 9 | 9 | 9 | 10 | 10 | 10 | 9 | 10 | 9 | 10 | 10 | 10 |
| Red wine (Carlo Rossi | 7 | 7 | 7 | 6 | 7 | 7 | 9 | 5 | 8 | 9 | 7 | 6 |
| burgundy) | | | | | | | | | | | | |
| Hot coffee | 4 | 4 | 4 | 4 | 3 | 7 | 6 | 3 | 3 | 6 | 7 | 3 |
| Leneta ST1 | 5 | 7 | 7 | 9 | 5 | 6 | 6 | 5 | 6 | 6 | 5 | 4 |
| Total rating | 49 | 56 | 54 | 53 | 52 | 63 | 61 | 47 | 53 | 65 | 57 | 39 |

*Comparative Example 1

As shown by the data in Tables 7 and 8, the formulations using the polymers of the present disclosure (Runs 1-11) provide better gloss and stain resistance compared to the formulation using Comparative Example 1. Tint strength is higher for examples 2, 3, 5, 6, 9, 10, and 11, all of which have greater than 10% lower molecular weight polymer or greater than 10% of a combination of low molecular weight polymer and monomer in feed step 3.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-29. (canceled)

30. A multilayer particle comprising
(i) a first layer comprising a first copolymer with an Mn of greater than 50,000 g/mol derived from one or more soft ethylenically-unsaturated monomers, and one or more phosphorus-containing monomer; and
(ii) a second layer surrounding at least a portion of the first layer comprising a second polymer having an Mn of 500 g/mol to 50,000 g/mol, derived from one or more ethylenically-unsaturated monomer, and at least one ethylenically unsaturated acid monomer, wherein the second layer is prepared by a high temperature polymerization process.

31. The multilayer particle of claim 30, wherein the monomers are selected from the group consisting of methyl (meth)acrylate, 2-ethyl (meth)acrylate, n-butyl (meth)acrylate, t-butyl (meth)acrylate, i-butyl (meth)acrylate, cyclohexyl(meth)acrylate, 2-ethylhexyl (meth)acrylate, i-bornyl(meth)acrylate, 2-octyl(meth)acrylate, styrene, (meth)acrylic acid, itaconic acid, sulfur acid monomers and phosphorous acid monomers.

32. The multilayer particle of claim 30, wherein the second polymer is a hydrophilic polymer.

33. The multilayer particle of claim 30, wherein the second polymer has ethylenically unsaturated bonds.

34. The multilayer particle of claim 30, wherein the first copolymer is derived from
(ii) greater than 50% by weight of the total first layer monomer comprising one or more soft (meth)acrylate monomers; and
(ii) from 0.1% by weight to 5% by weight of the total first layer monomers comprising one or more phosphorus acid-containing monomers.

35. The multilayer particle of claim 30, wherein the second copolymer is derived from
(i) greater than 10% by weight of the total second layer monomer comprising at least one of one or more hard (meth)acrylate monomers, and styrene; and
(ii) from 2% by weight to 20% by weight of the total second layer monomers comprising one or more acid-containing monomer.

36. The multilayer particle of claim 30, wherein the second polymer comprises 2.5 wt. % to 40 wt. % of the total particle weight.

37. The multilayer particle of claim 30, wherein the first copolymer exhibits a Tg, as measured by differential scanning calorimetry (DSC) using the mid-point temperature as described in ASTM D3418-15, from −100° C. to 50° C.

38. The multilayer particle of claim 30, wherein the second copolymer exhibits a Tg, as measured by differential scanning calorimetry (DSC) using the mid-point temperature as described in ASTM D3418-15, from −50 ° C. to 250° C.

39. The multilayer particle of claim 30, wherein the first copolymer comprises styrene, methyl (meth)acrylate, 2-ethyl (meth)acrylate), n-butyl(meth)acrylate, t-butyl(meth)acrylate, i-butyl(meth)acrylate, cyclohexyl(meth)acrylate, 2-ethylhexyl (meth)acrylate, i-bornyl(meth)acrylate, 2-octyl (meth)acrylate or a combination thereof

40. The multilayer particle of claim 30, wherein the second copolymer comprises methyl (meth)acrylate, 2-ethyl (meth)acrylate, styrene, n-butyl (meth)acrylate, t-butyl (meth)acrylate, i-butyl (meth)acrylate, cyclohexyl (meth)acrylate, 2-ethylhexyl (meth)acrylate, 2-octy (meth)acrylate, i-bornyl(meth)acrylate or a combination thereof.

41. The multilayer particle of claim 30, wherein the at least one ethylenically unsaturated acid monomer is selected from the group consisting of carboxylic acid-monomer, dicarboxylic acid monomer, sulfur acid-monomer, phosphorous acid-monomer, and combinations thereof

42. The multilayer particle of claim 41, wherein the carboxylic acid-containing monomers are selected from the group consisting of acrylic acid, methacrylic acid, itaconic acid, maleic acid, fumaric acid, and combinations thereof.

43. The multilayer particle of claim 30, wherein the phosphorus-containing monomers are selected from the group consisting of 2-phosphoethyl (meth)acrylate, 2-phosphopropyl (meth)acrylate, 3-phosphopropyl (meth)acrylate, 4-phosphobutyl (meth)acrylate, 3-phospho-2-hydroxypropyl (meth)acrylate, vinylphosphonic acid, methyl vinylphosphonic acid, alkyl or ethyl methacrylate phosphate, phosphate esters of polypropylene glycol mono (meth)acrylate, phosphate esters of polyethylene glycol mono (meth)acrylate, phosphate esters of mixture of polypropylene glycol mono (meth)acrylate and polyethylene glycol mono (meth)acrylate, and mixtures thereof.

44. The multilayer particle of claim 30, wherein the weight ratio of the first copolymer to the second copolymer is in a range of from 40:60 to 95:5.

45. The multilayer particle of claim 30, wherein the first polymer further comprises a self-crosslinker selected from the group consisting of a combination of acetoacetyl ethyl methacrylate (AAEM) and a polyamine or, a combination of diacetone acrylamide (DAAM) and adipic dihydrazide (ADDH).

46. A method of producing the multilayer particles of claim 30, the method comprising:
a) producing a first layer comprising a first polymer by emulsion polymerization;
b) producing a low molecular weight second polymer with Mn less than 50,000 g/mol by high temperature polymerization in a different reactor;
c) forming an aqueous solution comprising the second polymer; and
d) feeding the aqueous solution comprising the second polymer on to the first layer in the presence of a free radical polymerization initiator.

47. The method of claim 46, wherein the emulsion polymerization is carried out at a first temperature of less than or equal to 95° C., and the high temperature polymerization is carried out at a second temperature of greater than or equal to 120° C.

48. The method of claim 46, wherein step d) is conducted at a temperature of less than or equal to 95° C.

49. A composition comprising the multilayer particles of claim 30, wherein the composition comprises an aqueous dispersion.

50. The composition of claim 49, wherein the aqueous dispersion includes greater than 40% solids.

51. A coating, comprising:
the aqueous composition of claim 49; and
one or more of pigments, dispersants, fillers, coalescents, pH modifying agents, plasticizers, defoamers, surfactants, thickeners, biocides, co-solvents, and combinations thereof.

52. A method of producing the multilayer particles of claim 30, the method comprising:
a) producing a first layer comprising a first polymer by emulsion polymerization;
b) producing a low molecular weight second polymer with Mn less than 50,000 g/mol by high temperature polymerization in a different reactor;
c) forming an aqueous solution comprising the second polymer and one or more ethylenically unsaturated monomers; and
d) feeding the aqueous solution comprising the second polymer and the one or more ethylenically unsaturated monomers onto the first layer in the presence of a free radical polymerization initiator.

53. The method of claim 52, wherein the one or more ethylenically unsaturated monomers is selected from the group consisting of methyl (meth)acrylate, 2-ethyl (meth)acrylate, n-butyl (meth)acrylate, t-butyl (meth)acrylate, i-butyl (meth)acrylate, cyclohexyl(meth)acrylate, 2-ethylhexyl (meth)acrylate, 2-octyl (meth)acrylate, i-bornyl(meth)acrylate, styrene, a (meth)acrylic acid, itaconic acid, sulfur acid monomers and phosphorous acid monomers.

54. The method of claim 52 wherein the one or more ethylenically unsaturated monomers does not include acid functional monomers (meth)acrylic acid, itaconic acid, sulfur acid monomers and phosphorous acid monomers

55. The method of claim 52, wherein the one or more ethylenically unsaturated monomers includes a self-crosslinker selected from the group consisting of a combination of acetoacetyl ethyl methacrylate (AAEM) and a polyamine or, a combination of diacetone acrylamide (DAAM) and adipic dihydrazide (ADDH).

56. The method of claim 53, wherein steps c is substantially free of surfactants.

57. The method of claim 53, where the weight ratio of first polymer to second polymer is 50:50 to 97.5 to 2.5.

58. A multilayer particle comprising:
(i) a first layer comprising a first copolymer with an Mn of greater than 50,000 g/mol derived from one or more soft ethylenically-unsaturated monomers and one or more phosphorus-containing monomers; and
(ii) a second layer surrounding at least a portion of the first layer comprising a second polymer having an Mn of 500 g/mol to 50,000 g/mol, derived from a polyurethane polymer.
